(19) United States
(12) Patent Application Publication
(10) Pub. No.: US 2025/0376544 A1
(43) Pub. Date: Dec. 11, 2025

(54) DESULFURIZATION METHOD FOR SULFUR-CROSSLINKED RUBBER

(71) Applicant: TOYODA GOSEI CO., LTD., Kiyosu-shi (JP)

(72) Inventors: Akishige SEO, Aichi (JP); Tatsuya AO, Aichi (JP)

(21) Appl. No.: 19/226,894

(22) Filed: Jun. 3, 2025

(30) Foreign Application Priority Data
Jun. 7, 2024 (JP) 2024-092723

(51) Int. Cl. C08C 19/00; C08L 15/00

(52) U.S. Cl. CPC C08C 19/085; C08L 15/00

(57) ABSTRACT

A desulfurization method for a sulfur-crosslinked rubber, including: adding, to the sulfur-crosslinked rubber, at least one selected from the group consisting of a primary phosphine oxide and a secondary phosphine oxide and an analog of the phosphine oxide; a primary phosphine and a secondary phosphine which become oxides when oxidized and an analog of the phosphine; a sulfenic acid; and a sulfinic acid, as a desulfurization agent which acts on a sulfur bond in the sulfur-crosslinked rubber and cleaves the sulfur bond; and applying a shear force and heating.

### CROSS REFERENCE TO RELATED APPLICATION

This application is based on and claims priority under 35 USC 119 from Japanese Patent Application No. 2024-092723 filed on Jun. 7, 2024.

### TECHNICAL FIELD

The present disclosure relates to a desulfurization method for a sulfur-crosslinked rubber.

### BACKGROUND ART

As a desulfurization method for a sulfur-crosslinked rubber (in particular, a method in which a used sulfur-crosslinked rubber is desulfurized to obtain a reusable regenerated desulfurized rubber), currently, a method (shear desulfurization) in which a sulfur-crosslinked rubber is melted and kneaded to be physically desulfurized in a state in which a high shear flow field is formed is general. Patent Literature 1 discloses a method for producing a regenerated desulfurized rubber in which sulfur-crosslinking bonds are cleaved by pulverizing a sulfur-crosslinked rubber containing carbon black, charging the pulverized rubber into a twin screw extruder, and subjecting the pulverized rubber to a desulfurization treatment of applying a shear stress of 10 to 150 kg/cm² with heating the pulverized rubber to a temperature of 180 to 350° C. Patent Literature 1 also discloses that a desulfurization agent is used in combination in the shear desulfurization.

However, in the shear desulfurization, there is a problem of deterioration in physical properties (low selectivity) due to cleavage of a rubber main chain (except for S—S bond and C—S bond). At present, it is difficult to restore a regenerated desulfurized rubber to the same state as a virgin rubber. In addition, the desulfurization is carried out under high-temperature conditions.

On the other hand, in a method (chemical desulfurization) in which a sulfur bond in a structure of the sulfur-crosslinked rubber is chemically cleaved by a desulfurization agent (reclaiming agent) and desulfurized, since the cleavage selectively proceeds with respect to the sulfur bond, the main chain is less likely to be cleaved. Therefore, the regenerated desulfurized rubber obtained by the chemical desulfurization can maintain the same molecular weight as that of the virgin rubber, and the deterioration in physical properties is prevented. In addition, the desulfurization can be carried out under a mild condition.

Examples of the desulfurization agent include disulfide compounds (R—S—S—R), thiol compounds (R—SH), dimethyl sulfoxide (DMSO), and amine compounds (NR₃). The desulfurization agent disclosed in Patent Literature 1 is a diaryl disulfide, a dihexyl disulfide, or a thiophenol-iron oxide. Patent Literature 2 discloses a phenyl-hydrazine-iron chloride, a triphenylphosphine, thiol, or a disulfide as a desulfurization agent. Patent Literature 3 discloses an amine compound (octylamine, hexadecylamine, dioctylamine, trioctylamine, benzylamine, or 4-piperidinopiperidine) as a desulfurization agent. Patent Literature 4 discloses that an amine compound that is solid at 25° C. is used in order to control a heating temperature to 100° C. or lower, and specifically discloses a long chain alkyl amine compound (hexadecylamine, dodecylamine, stearylamine) having 12 to 18 carbon atoms.

However, since all of these desulfurization agents are a group of compounds that emit a specific odor, a physical burden is generated on an operator due to the odor generated during desulfurization, and a regenerated rubber after desulfurization also has an odor, which makes it difficult to use the regenerated rubber as a recycled material.
Patent Literature 1: JPH09-227724A
Patent Literature 2: Japanese Patent Application Publication No. 2010-535912
Patent Literature 3: Japanese Patent Application Publication No. 2003-510437
Patent Literature 4: JP2023-92683A

### SUMMARY OF INVENTION

Therefore, an object of the present invention is to effectively desulfurize a sulfur-crosslinked rubber while suppressing odor caused by the desulfurization agent during and after desulfurization and controlling the deterioration in physical properties, by promoting chemical desulfurization with the desulfurization agent through the application of shearing and heating.

[1] A desulfurization method for a sulfur-crosslinked rubber, including:
adding, to the sulfur-crosslinked rubber, at least one selected from the group consisting of a primary phosphine oxide and a secondary phosphine oxide and an analog of the phosphine oxide; a primary phosphine and a secondary phosphine which become oxides when oxidized and an analog of the phosphine; a sulfenic acid; and a sulfinic acid, as a desulfurization agent which acts on a sulfur bond in the sulfur-crosslinked rubber and cleaves the sulfur bond; and
applying a shear force and heating.

[2] The desulfurization method for a sulfur-crosslinked rubber according to [1], in which a heating temperature during the heating is 100 to 400° C.

### <Estimation of Desulfurization Reaction Using Employed Desulfurization Agent>

A secondary phosphine oxide that can be described as R1R2HP═O (R1 and R2 are not particularly limited) is in a chemical equilibrium state such as R1R2HP═O<=>R1R2P—OH, and in particular, R1R2P—OH reacts nucleophilically with sulfur of the sulfur-crosslinked rubber, finally causing desulfurization. A primary phosphine oxide also causes the same reaction mechanism. However, in a case of a tertiary phosphine oxide, the same reaction does not proceed. Sulfenic acid (RSOH) and sulfinic acid (RS(O)OH) also cause the same reaction mechanism.

More specifically, using diphenylphosphine oxide (DPPO) as an example, it is estimated as shown in the following Chemical Formula 1.

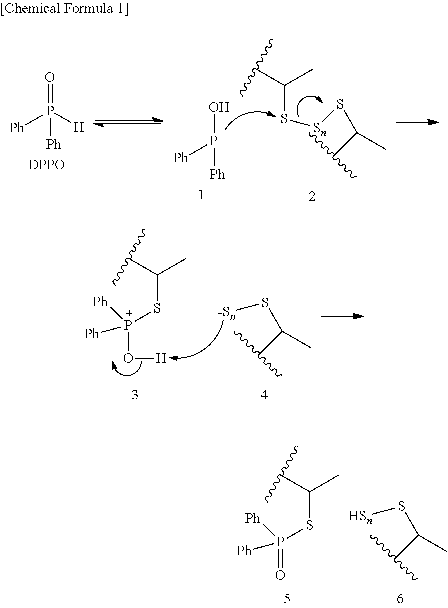

The DPPO is in a chemical equilibrium state with a compound 1 (bias is on DPPO side). The compound 1 attacks sulfur of the sulfur-crosslinked rubber, an S—S bond is cleaved, and compounds 3 and 4 are obtained. Here, negatively charged sulfur of the compound 4 receives protons of the compound 3 and gives compounds 5 and 6. The desulfurization proceeds through the same process.

The desulfurization agent of the present invention selectively reacts with a sulfur bond in the rubber and cleaves the sulfur bond, and thus even when the desulfurization proceeds, cleavage of a main chain of the rubber is less likely to occur, and deterioration in physical properties can be prevented.

In addition, since the desulfurization agent of the present invention generates almost no or less odor than the desulfurization agent described in the section of the background art, the odor generated during desulfurization is prevented, and the odor is less likely to remain in the rubber after desulfurization.

According to the present invention, it is possible to effectively desulfurize a sulfur-crosslinked rubber while suppressing odor caused by the desulfurization agent during and after desulfurization and controlling the deterioration in physical properties, by promoting chemical desulfurization with the desulfurization agent through the application of shearing and heating.

### DESCRIPTION OF EMBODIMENTS

### <1> Sulfur-Crosslinked Rubber

A rubber type of the sulfur-crosslinked rubber is not particularly limited, and examples thereof include ethylene propylene rubber (EPDM, EPM), natural rubber (NR), isoprene rubber (IR), butyl rubber (IIR), butadiene rubber (BR), styrene-butadiene rubber (SBR), chloroprene rubber (CR), and nitrile rubber (NBR).

The sulfur-crosslinked rubber is preferably a pulverized product in a shape of a piece, a particle, or the like which is pulverized before desulfurization.

As the sulfur-crosslinked rubber, a used sulfur-crosslinked rubber can be suitably used, and a use time and a use state thereof are not particularly limited. According to the present invention, the used sulfur-crosslinked rubber can be desulfurized into a reusable regenerated desulfurized rubber.

### <2> Desulfurization Agent

As described above, as the desulfurization agent, at least one selected from the group consisting of a primary phosphine oxide and a secondary phosphine oxide and an analog thereof (phosphorous acid esters and the like), a primary phosphine and a secondary phosphine which become oxides when oxidized, and an analog thereof, a sulfenic acid, and a sulfinic acid is used.

Specific examples thereof include the diphenylphosphine oxide (DPPO), a di-p-tolylphosphine oxide, a diadamantyl phosphine, a bis-3,5-dimethylphenylphosphine oxide, a dicyclohexylphosphine oxide, a di-4-methoxyphenylphosphine oxide, a diphenylphosphine, and a diethyl phosphite that are represented by the following Chemical Formula 2.

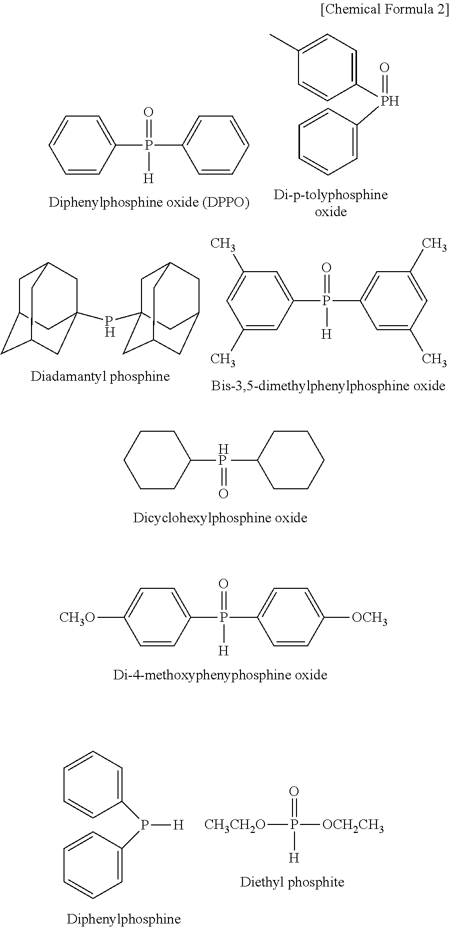

An addition amount of the desulfurization agent is not particularly limited because the addition amount of the desulfurization agent changes appropriately depending on the rubber type, the heating temperature, a heating time, and the like, but the addition amount is, for example, 0.5 to 25 equivalents per 1 g of the rubber, and preferably 1 to 20 equivalents per 1 g of the rubber. An appropriate addition amount of the desulfurization agent when no solvent is added is as described above.

### <3> Other Additives

In addition to the desulfurization agent, a radical initiator for generating a radical active species from the desulfurization agent may be added. The radical initiator is preferably at least one selected from the group consisting of an azo compound and a peroxide compound. This is because the compounds generate almost no or little odor, and are easily to obtain.

Examples of the azo compound include 2,2′-azobis(isobutyronitrile) (AIBN), 2,2′-azobis(4-methoxy-2,4-dimethylvaleronitrile), 2,2′-azobis(2,4-dimethylvaleronitrile), 1,1′-azobis(cyclohexane-1-carbonitrile), 2,2′-azobis(2-methylbutyronitrile), dimethyl 2,2′-azobis(isobutyrate), and 4,4′-azobis(4-cyanovaleric acid).

Examples of the peroxide compound include di-tert-butyl peroxide, cumene hydroperoxide, dicumyl peroxide, and benzoyl peroxide (BPO).

However, since many radical initiators, such as AIBN, have self-reactivity and must be handled carefully, it is preferable not to add a radical initiator from the viewpoint of ease of handling.

In addition to the desulfurization agent, a solvent may be added.

However, by not adding the solvent, the following effects which are less likely to be obtained in a case where the solvent is added are obtained. (1) For example, a rubber is easily kneaded with a kneading extruder, and is very practical. (2) Drying or the like of the rubber after reaction is unnecessary, which leads to simplification of post-processing. (3) An environmental load can be reduced.

Therefore, in a case where these effects are emphasized, it is preferable that the solvent is not added.

### <4> Application of Shear Force and Heating

Application of a shear force to the sulfur-crosslinked rubber and heating may be carried out separately or simultaneously.

A method in which the application of the shear force and the heating are carried out separately is not particularly limited, and examples thereof include a method in which a shear force is applied to the sulfur-crosslinked rubber by a mixing roll or the like and then the sulfur-crosslinked rubber is heated by a heating device.

An example of a method where shear force and heating are applied simultaneously include kneading and extruding the sulfur-crosslinked rubber using a kneading extruder (e.g., a twin screw extruder), with the heating provided by shearing heat during the application of shear force. When the kneading extrusion is carried out by a twin screw extruder whose temperature is set to 50 to 150° C., the temperature becomes about 150 to 275° C. due to shear heat generation.

The heating temperature is not particularly limited because it varies depending on a rubber type, a heating time, and the like, but is preferably from 100 to 400° C., and more preferably from 110 to 300° C. This is because when the heating temperature is lower than 100° C., fluidity of the crosslinked rubber is low, and therefore there is a tendency that cleavage of crosslinking of rubber molecules and the like does not sufficiently occur, and when the heating temperature is higher than 400° C., there is a tendency that deterioration of the rubber occurs.

### <5> Index of Desulfurization

When the rubber comes into contact with the solvent, the rubber absorbs the solvent and swells. This swelling also occurs in the rubber before desulfurization, but the more the desulfurization proceeds, the higher a swelling ratio obtained by the following formula 1 is. This is because the solvent enters when the sulfur bond is cleaved.

Swelling ratio (%)=(swelling weight−dry weight)/dry weight×100 (Formula 1)

Therefore, in the present invention, the rubber after desulfurization (dry weight: 1 g) was immersed in toluene as a solvent at room temperature for 24 hours, and then the swelling weight was measured to determine the swelling ratio of the rubber after desulfurization as an index of desulfurization.

However, since the ease of swelling varies depending on a rubber type, it is difficult to uniformly evaluate a degree of desulfurization of various rubbers by the swelling ratio, and each rubber type has a preferable swelling ratio. For example, a swelling ratio of a natural rubber after desulfurization is preferably 350% or more (it is considered that progress of desulfurization is substantially recognized), and more preferably 500% or more. A swelling ratio of a mixture of the natural rubber and butadiene rubber after desulfurization is preferably 250% or more (it is considered that progress of desulfurization is substantially recognized), and more preferably 400% or more.

### Examples

Next, Examples of the present invention will be described. Materials, conditions, structures, shapes, and dimensions of Examples are merely examples, and can be appropriately modified without departing from the spirit of the invention.

### <Preparation of Sulfur-Crosslinked Natural Rubber and Mixed Rubber>

A sulfur-crosslinked natural rubber and a sulfur-crosslinked mixed rubber (natural rubber and butadiene rubber) were prepared according to a formulation shown in Table 1.

TABLE 1

| | Sulfur-crosslinked | Sulfur-crosslinked |
|---|---|---|
| | natural rubber | mixed rubber |
| Natural rubber (parts | 100 | 70 |
| by mass, the same | | |
| applies hereinafter) | | |
| Butadiene rubber | | 30 |
| Carbon black | 35 | 50 |
| Zinc oxide | 5 | 3 |
| Stearic acid | 2 | 2 |
| Antioxidant | | 1 |
| Sulfur | 2.25 | 1 |
| Vulcanization accelerator | 1 | 1.5 |

Details of each material in Table 1 are as follows.
Natural rubber: “SVR-CV60” manufactured by DAU TIENG RUBBER CORPORATION
Butadiene rubber: “BR01” manufactured by ENEOS Materials Corporation
Carbon black: “SEAST 7HM” manufactured by TOKAI CARBON CO., LTD.
Zinc oxide: “Zinc oxide type 2” manufactured by HAKUSUI TECH CO., LTD.
Stearic acid: “LUNAC S-50V” manufactured by Kao Corporation
Antioxidant: 6PPD, “NOCRAC 6C” manufactured by OUCHI SHINKO CHEMICAL INDUSTRIAL CO., LTD.
Vulcanization accelerator: “NOCCELER CZ” manufactured by OUCHI SHINKO CHEMICAL INDUSTRIAL CO., LTD.

In accordance with the formulation shown in Table 1, a 1.5 L Banbury mixer (hereinafter, referred to as “1.5 L Banbury”) manufactured by KOBE STEEL, LTD. was used, and in a first mixing stage, compounding agents other than sulfur and a vulcanization accelerator were added to and kneaded with a rubber component. Subsequently, a kneaded product obtained by a mixing roll (model number: 3729, roll diameter: 8 inches) (hereinafter, referred to as “8-inch roll”) manufactured by KANSAI ROLL Co., Ltd. was added with and kneaded with sulfur and a vulcanization accelerator, and press-molded at 150° C. for 30 minutes to prepare a sulfur-crosslinked natural rubber composition and a sulfur-crosslinked mixed rubber composition, respectively.

### <Desulfurization Test>

As a desulfurization test of the prepared sulfur-crosslinked natural rubber or sulfur-crosslinked mixed rubber, Examples 1 to 4 and Comparative Examples 1 to 4 shown in Table 2 were carried out.

TABLE 2

| | | Comparative | | | Comparative | Comparative | | | Comparative |
|---|---|---|---|---|---|---|---|---|---|
| | | Example 1 | Example 1 | Example 2 | Example 2 | Example 3 | Example3 | Example 4 | Example 4 |
| Sulfur | Natural rubber | 100 | 100 | 100 | 100 | | | | |
| crosslinked | Mixture of | | | | | 100 | 100 | 100 | 100 |
| rubber | natural rubber | | | | | | | | |
| [g] | and butadiene | | | | | | | | |
| | rubber | | | | | | | | |
| Desulfurization | Diphenylphosphine | | 5 | 10 | | | 5 | 10 | |
| agent [g] | oxide | | | | | | | | |
| | 2,2′- | | | | 5 | | | | 5 |
| | dithiodianiline | | | | | | | | |
| (1) Application | 8-inch roll | Carried | Carried | Carried | Carried | Carried | Carried | Carried | Carried |
| of shear force | | out | out | out | out | out | out | out | out |
| (2) Heating | 100° C. × 5 h | Carried | Carried | Carried | — | Carried | Carried | Carried | — |
| | | out | out | out | | out | out | out | |
| Swelling | After (1) | 210 | 250 | 279 | 230 | 210 | 220 | 231 | 219 |
| degree of | After (2) | 212 | 372 | 393 | — | 211 | 263 | 278 | — |
| rubber [%] | | | | | | | | | |

In Example 1, a sulfur-crosslinked natural rubber was pulverized with an 8-inch roll, 5 g of DPPO was added as a desulfurization agent to 100 g of the pulverized sulfur-crosslinked natural rubber and mixed, and the mixture was subjected to a desulfurization treatment by the following methods (1) and (2).
(1) Application of shear force: a shear force was applied to the natural rubber. Specifically, the natural rubber was kneaded at room temperature over about 30 minutes by manually repeating an operation of placing the natural rubber into the 8-inch roll from above, kneading the natural rubber, and dropping the natural rubber downward.
(2) Heating: subsequently, the natural rubber was placed in a thermostatic chamber, heated to 100° C., and held for 5 hours to obtain a desulfurized regenerated rubber.

Example 2 is different from Example 1 in that the DPPO was 10 g.

Comparative Example 1 is different from Example 1 in that the DPPO was not added.

Comparative Example 2 is different from Example 1 in that 2,2′-dithiodianiline was added instead of the DPPO and the heating of (2) was not carried out.

In Example 3, a sulfur-crosslinked mixed rubber (natural rubber and butadiene rubber) was pulverized by an 8-inch roll, 5 g of DPPO was added as a desulfurization agent to 100 g of the pulverized sulfur-crosslinked mixed rubber and mixed, and the mixture was desulfurized by the same methods (1) and (2) as in Example 1.

Example 4 is different from Example 3 in that the DPPO was 10 g.

Comparative Example 3 is different from Example 3 in that the DPPO was not added.

Comparative Example 4 is different from Example 3 in that 2,2′-dithiodianiline was added instead of the DPPO and the heating of (2) was not carried out.

In Examples 1 to 4 and Comparative Examples 1 to 4, generation of odor during treatment and residue of odor after treatment were small, and those were all within an allowable range.

After the reaction, a swelling ratio of the rubber after kneading of (1) and after heating of (2) was determined for each of Examples and Comparative Examples by the method described in the section of “<5> Index of Desulfurization”. Results are shown in Table 2.

In Comparative Examples 1 and 3, the swelling ratio after kneading is low, and desulfurization is not observed. It is considered that kneading with the 8-inch roll at room temperature for only about 30 minutes was insufficient for shear desulfurization to proceed. The swelling ratio after heating is also low.

The swelling ratio after kneading in Examples 1 and 2 was higher than that in Comparative Example 1, and the swelling ratio after kneading in Examples 3 and 4 was higher than that in Comparative Example 3, and it is considered that chemical desulfurization started to proceed by the application of shear force in both cases. In addition, the swelling ratio after heating is even higher, and it is considered that the chemical desulfurization is further promoted by the heating to obtain a desulfurized regenerated rubber. That is, it was verified that the desulfurization can be carried out more effectively by promoting the chemical desulfurization by the application of the shear force and the heating.

### <Preparation of Sulfur-Crosslinked Rubber Using New Material Rubber and Desulfurized Regenerated Rubber>

The desulfurized regenerated rubber and the like obtained as described above were added to a new material rubber in ratios shown in Table 3, and mixed and vulcanized to prepare sulfur-crosslinked rubbers (vulcanized rubbers 1 to 9).

TABLE 3

| | | Vulca- | Vulca- | Vulca- | Vulca- | Vulca- | Vulca- | Vulca- | Vulca- | Vulca- |
|---|---|---|---|---|---|---|---|---|---|---|
| | | nized | nized | nized | nized | nized | nized | nized | nized | nized |
| | | rubber 1 | rubber 2 | rubber 3 | rubber 4 | rubber 5 | rubber 6 | rubber 7 | rubber 8 | rubber 9 |
| New | Natural | 100 | 100 | 100 | 100 | 100 | 70 | 70 | 70 | 70 |
| material | rubber | | | | | | | | | |
| rubber | Butadiene | | | | | | 30 | 30 | 30 | 30 |
| (parts | rubber | | | | | | | | | |
| by mass) | Carbon black | 35 | 35 | 35 | 35 | 35 | 50 | 50 | 50 | 50 |
| | Zinc oxide | 5 | 5 | 5 | 5 | 5 | 3 | 3 | 3 | 3 |
| | Stearic acid | 2 | 2 | 2 | 2 | 2 | 2 | 2 | 2 | 2 |
| | Antioxidant | | | | | | 1 | 1 | 1 | 1 |
| Added | Non- | 10 | | | | | | | | |
| rubber | desulfurized | | | | | | | | | |
| (parts | rubber of | | | | | | | | | |
| by mass) | Comparative | | | | | | | | | |
| | Example 1 | | | | | | | | | |
| | Desulfurized | | 10 | | | | | | | |
| | regenerated | | | | | | | | | |
| | rubber of | | | | | | | | | |
| | Example 1 | | | | | | | | | |
| | Desulfurized | | | 10 | | | | | | |
| | regenerated | | | | | | | | | |
| | rubber of | | | | | | | | | |
| | Example 2 | | | | | | | | | |
| | Desulfurized | | | | 10 | | | | | |
| | regenerated | | | | | | | | | |
| | rubber of | | | | | | | | | |
| | Comparative | | | | | | | | | |
| | Example 2 | | | | | | | | | |
| | Non- | | | | | | 20 | | | |
| | desulfurized | | | | | | | | | |
| | rubber of | | | | | | | | | |
| | Comparative | | | | | | | | | |
| | Example 3 | | | | | | | | | |
| | Desulfurized | | | | | | | 20 | | |
| | regenerated | | | | | | | | | |
| | rubber of | | | | | | | | | |
| | Example 3 | | | | | | | | | |
| | Desulfurized | | | | | | | | 20 | |
| | regenerated | | | | | | | | | |
| | rubber of | | | | | | | | | |
| | Example 4 | | | | | | | | | |
| | Desulfurized | | | | | | | | | 20 |
| | regenerated | | | | | | | | | |
| | rubber of | | | | | | | | | |
| | Comparative | | | | | | | | | |
| | Example 4 | | | | | | | | | |
| Crosslinking | Sulfur | 2.25 | 2.25 | 2.25 | 2.25 | 2.25 | 1 | 1 | 1 | 1 |
| agent (parts | Vulcanization | 1 | 1 | 1 | 1 | 1 | 1.5 | 1.5 | 1.5 | 1.5 |
| by mass) | accelerator | | | | | | | | | |
| Physical | Amount of | Large | Medium | Small | Large | None | Large | Medium | Medium | Large |
| properties | bulges | | | | | | | | | |
| | (visual) | | | | | | | | | |
| | Tear strength | 100 | 105 | 104 | 118 | — | 100 | 112 | 107 | 98 |
| | expressed as | | | | | | | | | |
| | a converted | | | | | | | | | |
| | value based | | | | | | | | | |
| | on vulcanized | | | | | | | | | |
| | rubber 1 or 6 | | | | | | | | | |
| | Curelast t90 | 11.3 | 11.3 | 11.3 | 10.8 | 11.2 | — | — | — | — |
| | [min] | | | | | | | | | |
| | Rubber | 58 | 58 | 58 | 59 | 58 | — | — | — | — |
| | Shore A | | | | | | | | | |
| | hardness | | | | | | | | | |

Details of the respective materials (natural rubber, butadiene rubber, carbon black, zinc oxide, stearic acid, antioxidant, and vulcanization accelerator) in Table 3 are the same as details of the respective materials in Table 1 described above.

In Table 3, a material of the new material rubber was kneaded by a 1.5 L Banbury, and this was used as a master batch. Next, a material of an additive rubber and a material of a crosslinking agent were added to the master batch, kneaded by an 8-inch roll, and press-molded (vulcanization molded) at 145° C. for 30 minutes to obtain sulfur-crosslinked rubbers (vulcanized rubbers 1 to 9) for evaluation.

The vulcanized rubbers 1 to 9 were evaluated for physical properties as described below.

Amount of bulges: An amount of bulges (protruding pieces) appearing on a surface of the rubber was visually observed.

Tear strength: In accordance with JIS K6252-1:2015, tear strength was measured using crescent-shaped test specimens. The values for vulcanized rubbers 2 to 4 were described as indices with the value for vulcanized rubber 1 set at 100. Similarly, the values for vulcanized rubbers 7 and 8 were described as indices with the value for vulcanized rubber 6 set at 100.
Curelast t90: measured by a vulcanization characteristic tester in accordance with JIS K6300-2:2001.
Rubber Shore A hardness: measured in accordance with JIS K6253-3:2012.

Compared to the vulcanized rubbers 1 and 6 (added with non-desulfurized rubber), the vulcanized rubbers 2, 3, 7, and 8 (added with desulfurized regenerated rubber) were confirmed to have a reduction in the number of bulges, and the tear strength was improved. This is considered to be due to the fact that desulfurization of the added regenerated rubber has proceeded and a network structure has been reduced, so that the regenerated rubber is easily mixed with an unvulcanized new material rubber.

The vulcanized rubber 4 had a larger amount of bulges and higher tear strength than the others. This is considered to be affected by 2,2′-dithiodianiline used as a desulfurization agent.

The present invention is not limited to the aforementioned Examples and can be appropriately modified and carried out within a scope that does not deviate from the spirit of the invention.

What is claimed is:

1. A desulfurization method for a sulfur-crosslinked rubber, comprising:
adding, to the sulfur-crosslinked rubber, at least one selected from the group consisting of a primary phosphine oxide and a secondary phosphine oxide and an analog of the phosphine oxide; a primary phosphine and a secondary phosphine which become oxides when oxidized and an analog of the phosphine; a sulfenic acid; and a sulfinic acid, as a desulfurization agent which acts on a sulfur bond in the sulfur-crosslinked rubber and cleaves the sulfur bond; and
applying a shear force and heating.

2. The desulfurization method for a sulfur-crosslinked rubber according to claim 1, wherein a temperature for the heating is 100 to 400° C.
